(19) United States
(12) Patent Application Publication
(10) Pub. No.: US 2010/0092637 A1
(43) Pub. Date: Apr. 15, 2010

(54) Seasoning Porous Carbon Material and Associate Process

(75) Inventor: Jenn-shing Wang, Tainan Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: SAN YUAN BIOINDUSTRY CO., LTD., Kaohsiung (TW)

(21) Appl. No.: 12/640,533

(22) Filed: Dec. 17, 2009

Related U.S. Application Data
(62) Division of application No. 11/566,949, filed on Dec. 5, 2006.

(51) Int. Cl. A23L 1/22

(52) U.S. Cl. 426/533

(57) ABSTRACT

A porous carbon material functioning as a seasoning and its associate manufacturing process is comprised of having the material containing lignin heated and carbonized into a porous carrier with a given shape and distributed with releasable water base alkaloid for the porous carbon material to contact an object pending seasoning for the water base alkaloid to be released into and dissolved in the object pending seasoning.

### CROSS-REFERENCE TO RELATED APPLICATIONS

This application claims priority to, and is a Divisional of, U.S. patent application Ser. No. 11/566,949, filed on Dec. 5, 2006, now pending, which is hereby incorporated by reference in its entirety.

Although incorporated by reference in its entirety, no arguments or disclaimers made in the parent application apply to this divisional application. Any disclaimer that may have occurred during the prosecution of the above-referenced application(s) is hereby expressly rescinded. Consequently, the Patent Office is asked to review the new set of claims in view of all of the prior art of record and any search that the Office deems appropriate.

### BACKGROUND OF THE INVENTION

(a) Field of the Invention

The present invention relates to a seasoning, and more particularly to a porous carbon material and associate process and application as a seasoning

(b) Description of the Prior Art

Whereas, the active carbon attributes to the largest consumption among porous carbon materials, it is widely used in the filtration of potable water, deodorizing, and wastewater treatment by taking advantage its absorption capability. For example, bamboo carbon is known for its refined quality and porosities, larger specific surface area (200˜300 m²/g), and strong absorbability. Meanwhile, many applications of the bamboo carbon have been developed, e.g., the bamboo an active carbon material by providing construction of consistently distributed pores when activated with water steam; as a material for room humidity regulation by absorbing water containment to inhibit rise of ambient humidity thus to achieve the purpose of preventing proliferation of molds and microbes; as a deodorant to remove smells in the room, living room, toilet, and car and to clear the air since the bamboo carbon is very efficient to absorb particles of ambient odors; as a water purifying material to treat hazardous and impure substances found in water including residual chlorines in tap water by taking advantage of the powerful molecule absorption property of the bamboo carbon; and as a soil quality improvement material because that it has excellent property of absorbing carbon dioxide, and is water permeable and helps retaining water and fertility without getting rotten when pulverized and buried in soil to improve soil quality and promote good development for the roots of the crops.

However, the application developed for the feature of large specific surface area for porous carbon material is so far only limited to taking advantage of its absorbability; and there is the absence of having the porous carbon applied as a seasoning with associate manufacturing process up to date.

### SUMMARY OF THE INVENTION

The primary purpose of the present invention is to provide a porous carbon material as a seasoning to solve the problem of inconvenient operation in the seasoning of the edible and beverage.

Another purpose of the present invention is to provide a porous carbon material to solve the problem of the absence of popular application of water base alkaloid in the operation of seasoning

Another purpose of the present invention is to provide a porous carbon material to solve the problem that so far there is the absence of providing a compound seasoning by combining water base alkaloid with other seasoning additive.

To achieve these purposes, the present invention relates to a porous carbon material with seasoning property. A material containing lignin is heated and carbonized to form a porous carrier in a specific form and the porous carrier is distributed with water base alkaloid that can be released.

The material containing lignin includes 20%˜59% of cellulose, 20%˜35% of hemi-cellulose, 20%˜35% of lignin, and 1%˜10% of minerals.

The specific form of the material is related to the form either of stick, block or powder.

The material containing lignin is selected from any of the following items: bamboo, Chinese fir, pine, and Chinese cypress.

The porous carrier is further filled with a second composition.

The second composition is selected from any of the following substances or any combination of them: curry, salt, spice, alkaloid, vinegar, and sugar.

The alkaloid is any of the following substances or any combination of them: oxides, hydroxides, and sodium bicarbonates of silicone, potassium, magnesium, sodium, calcium, iron, and aluminum.

The present invention relates to a manufacturing process of the porous carbon material as a seasoning To achieve the purpose, a material containing lignin in a given shape is heated and carbonized into a porous carrier provided with multiple porosities and distributed with water base alkaloid.

Before the heating process, the material containing lignin is first molded into a given form.

The molding process includes any of the following processes or any combined process among them: cutting, peel removing, trimming, cambering, drilling, and surface covering.

The heating process is comprised of a pre-dehydration stage by fumigation (30˜110° C.), a temperature rising dehydration stage (111˜150° C.), an initial carbonization stage (151˜275° C.), a primary carbonization stage (276˜550° C.), and a refining stage (551˜950° C.).

The material containing lignin is a bamboo stick.

Before the heating process, the bamboo stick is cut into preset size, peeled and polished.

The heating process is provided under low oxygen containment and in multiple stages with each stage designated a specified heating time.

The multi-stage heating includes two hours at 30˜110° C.; four hours at 111˜150° C.; seven hours at 151˜275° C., fifteen hours at 276˜550° C.; and eight hours at 551˜950° C.

Upon completing the multi-stage heating, the cooling stage is followed to cool the finished products down to a proper temperature.

The material containing lignin is a Chinese fir stick put under thermal treatment at the temperature range of 720° C.˜2000° C.

The material containing lignin is a bamboo stick thermally treated with a temperature rise rate of 3˜10° C. per minute until reaching the temperature range of 550° C.˜2000° C.

A second composition is filled into multiply porosities of the porous carrier.

The second composition is filled into the multiple porosities by means of absorption and impregnation.

The second composition is selected from any of the following materials or any combination among them: curry, salt, spice, alkaloid, vinegar, and sugar.

The alkaloid is any of the following substances or any combination of them: oxides, hydroxides, and sodium bicarbonates of silicone, potassium, magnesium, sodium, calcium, iron, and aluminum.

The present invention relates to a manufacturing process of a seasoning porous carbon material essentially comprised of having a material containing lignin thermally treated for the material to be carbonized into a porous carrier containing multiple porosities and distributed with water base alkaloid before being molded into a given form.

The heating process includes a pre-dehydration stage by fumigation (30˜110° C.), a temperature rising dehydration stage (111˜150° C.), an initial carbonization stage (151˜275° C.), a primary carbonization stage (276˜550° C.), and a refining stage (551˜950° C.).

The heating process is provided under low oxygen containment and in multiple stages with each stage designated a specified heating time.

The multi-stage heating includes two hours at 30˜110° C.; four hours at 111˜150° C.; seven hours at 151˜275° C., fifteen hours at 276˜550° C.; and eight hours at 551˜950° C.

Upon completing the multi-stage heating, the cooling stage is followed to cool the finished products down to a proper temperature.

The molding process includes cutting, peel removing, milling, and trimming.

The material containing lignin is a Chinese fir stick put under thermal treatment at the temperature range of 720° C.˜2000° C.

The material containing lignin is a bamboo thermally treated with a temperature rise rate of 3˜10° C. per minute until reaching the temperature range of 300° C.˜2000° C.

Another second composition is filled into the multiple porosities of the porous carrier.

The second composition is filled into the multiple porosities by means of absorption and impregnation.

The second composition is selected from any of the following materials or any combination among them: curry, salt, spice, alkaloid, vinegar, and sugar.

The alkaloid is any of the following substances or any combination of them: oxides, hydroxides, and sodium bicarbonates of silicone, potassium, magnesium, sodium, calcium, iron, and aluminum.

The present invention relates to a method of seasoning with a porous carbon material is essentially achieved by having the porous carbon material containing water base alkaloid to contact an object pending seasoning for the water base alkaloid to be released and dissolved in the object pending seasoning.

The porous carbon material further carries a second composition for seasoning and the second composition is also released and dissolved in the object pending seasoning

Accordingly, the present invention provides the following effects:
1. The lignin contained in the plant releases its water base alkaloid composition when subject to heat, and the alkaloid contacts a water solution to produce hydration for the material to provide pH adjustment function.
2. When used in the seasoning of a hot beverage, the thermal dissolution will create massive large porosities in the porous carbon material to facilitate the water solution to fast enter into the porosities and react with the water base alkaloid during the seasoning process; and in turn the reaction diffuses rapidly into the water solution to carry away ions of alkaloid from the porous carbon thus to complete the seasoning process in a very short time.
3. Whereas the alkaloid relates to a natural product that is good to one's health, the porous carbon material produced from the process of the present invention is also related to a healthy seasoning
4. The porous carbon material is further utilized as a carrier to absorb or impregnate in the second seasoning composition for making a compound seasoning The second seasoning composition penetrates as a filling stuff into the porosities of the porous carbon material so to facilitate its dissolution in the blending process for changing the pH of the edible.
5. The seasoning formulation is carried in advance in a stick shaped porous carbon material to make the blending and seasoning at the same time.
6. The present invention changes the operation of seasoning to prevent from overdoing or shortage of doing the seasoning by having a proper amount of formulation of seasoning carried in the porous carbon material in advance.

### BRIEF DESCRIPTION OF THE DRAWINGS

FIG. 1 is a view showing a lay out of a porous carrier of the present invention.

FIG. 2 is an enlarged cross-sectional view of the porous carrier of the present invention taken from A-A in FIG. 2.

FIG. 3 is a schematic view showing a cap inserted onto the top of the porous carrier of the present invention.

FIG. 4 is a view showing details of alkaloid in porous carbon.

### DETAILED DESCRIPTION OF THE PREFERRED EMBODIMENTS

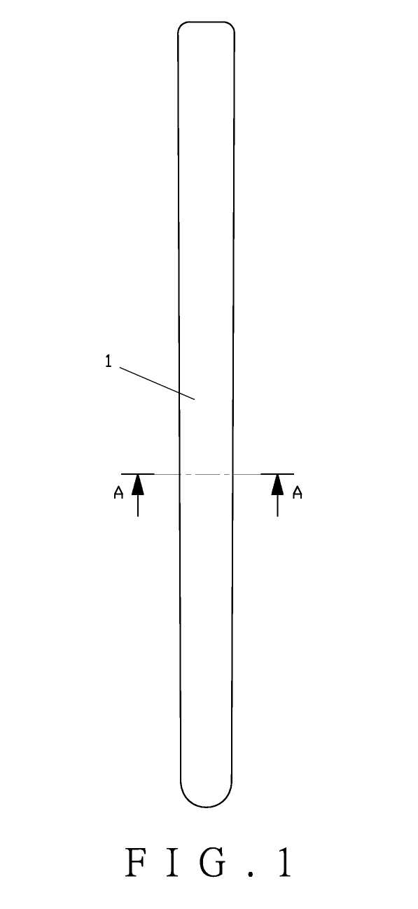

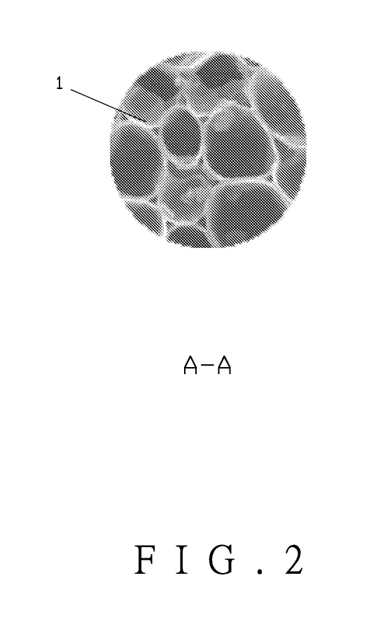

Referring to FIGS. 1 and 2, the present invention relates to a seasoning porous carbon material. The porous carbon material in a stick form containing lignin is heated and carbonized to become a porous carrier (1) containing water base alkaloid. The material containing lignin including 20%-59% of cellulose, 20%-35% of semi-cellulose, 20%-35% of lignin, and 1%-10% of minerals, is selected from any of the following materials: bamboo, Chinese fir, pine, and Chinese cypress. Multiple porosities in the porous carrier (1) contain a second composition for seasoning, which is selected form any of the following materials or any combination among them: curry, salt, spice, alkaloid (any of the oxide, hydroxide, and sodium bicarbonate of silicone, potassium, magnesium, sodium, calcium, iron, and aluminum or any combination of them), vinegar, and sugar. The porous carrier (1) is impregnated in a solution containing the second composition for the second composition to be attached in the porosities of the porous carrier (1). The porous carrier (1) may be made in any form including block, grain, or powder other than the stick.

The manufacturing process for the porous carbon material as a seasoning is essentially comprised of having bamboo or Chinese fir stick containing lignin to undergo a molding process including:
1. Cutting: cut the stick into a given length that fits best for blending purpose.
2. Peeling: skin of the stick is planed.
3. Grinding: having the molded sticks to grind against one another or use an emery wheel or sandpaper to grind and polish the sticks, and then the smooth stick is cambered (with burrs removed).
4. Drilling: may be provided but not a necessary process to facilitate hanging up the stick.

However, the molding process may be omitted in case of a material containing lignin already available in a given shape, e.g., a bamboo chopstick, and directly proceed to a multi-stage heating process.

The molded bamboo or Chinese fir stick is given the multi-stage heating process with each stage maintained a given heating time, wherein the bamboo stick is heated at a temperature rise rate at 3˜10° C./minute until reaching a constant range of 550° C.˜2000° C.; and Chinese fir, 720° C.˜2000° C. The multi-stage heating process includes a 2-hour pre-dehydration stage by fumigation (30˜110° C.), a 4-hour temperature rising dehydration stage (111˜150° C.), a 7-hour initial carbonization stage (151˜275° C.), a 15-hour primary carbonization stage (276˜550° C.), and an 8-hour refining stage (551˜950° C.). Each heating stage is performed under low oxygen containment.

Upon completing the multi-stage heating process, the cooling stage follows to cool the finished product down to a proper temperature (even under 200° C.) for the finish product to be carbonized into a porous carrier distributed with water base alkaloid. The second composition is filled either by absorption or impregnation into the multiple porosities of the porous carrier. The second composition is selected form any of the following materials or any combination among them: curry, salt, spice, alkaloid (any of the oxide, hydroxide, and sodium bicarbonate of silicone, potassium, magnesium, sodium, calcium, iron, and aluminum or any combination of them), vinegar, and sugar.

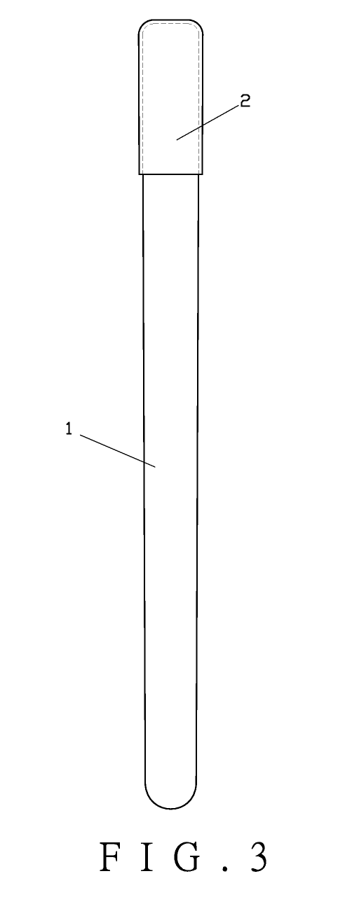

As illustrated in FIG. 3, the top of the carbonized porous carrier (1) is covered up with a plastic film or a cap (2) for easy holding.

Another manufacturing process of the present invention of a seasoning porous material is essentially comprised of having a bamboo material or Chinese fir (pine or Chinese cypress) thermally treated in multiple stages with each stage maintained a given heating time. In case of the bamboo material, it is heated at a temperature rise rate of 3° C.˜10° C/minute until reaching the constant temperature range of 300° C.˜2000° C.; and Chinese fir (pine or Chinese cypress), 720° C.˜2000° C. The multi-stage heating process includes a 2-hour pre-dehydration stage by fumigation (30˜110° C.), a 4-hour temperature rising dehydration stage (111˜150° C.), a 7-hour initial carbonization stage (151˜275° C.), a 15-hour primary carbonization stage (276˜550° C.), and an 8-hour refining stage (551˜950° C.). Each heating stage is performed under low oxygen containment.

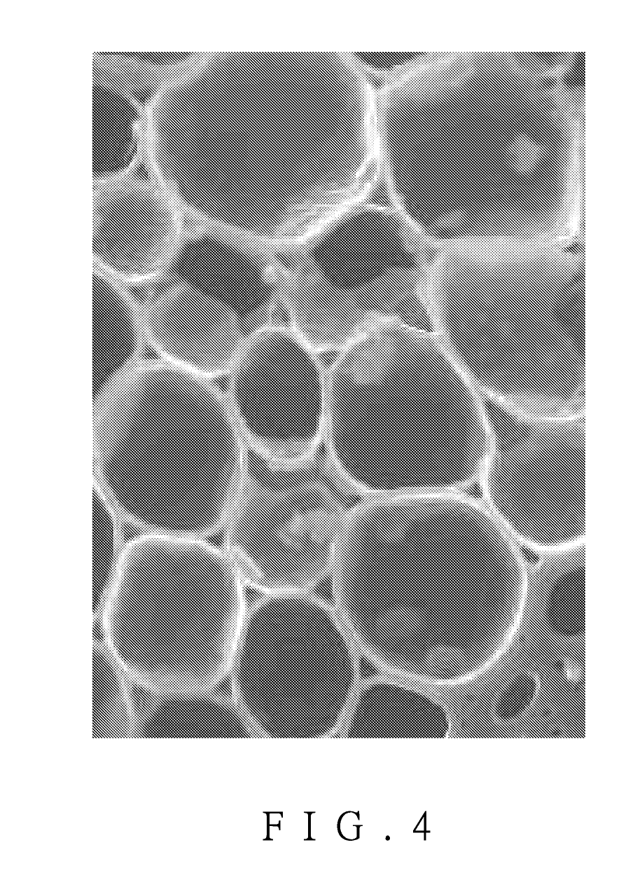

Upon completing the multi-stage heating process, the cooling stage follows to cool the finished product down to a proper temperature (even under 200° C.) for the finish product to be carbonized into a porous carrier distributed with water base alkaloid, as shown in FIG. 4. The porous carrier is further given the following molding process:
1. Cutting: cut the porous carrier into a given length that fits best for blending purpose.
2. Peeling: skin of the porous carrier is planed.
3. Grinding: having the porous carrier to grind against one another or use an emery wheel to grind and polish the porous carrier.
4. Trimming: burrs are removed.

Furthermore, either by absorption or impregnation, a second composition is filled in the multiple porosities of the porous carrier and the second is selected form any of the following materials or any combination among them: curry, salt, spice, alkaloid (any of the oxide, hydroxide, and sodium bicarbonate of silicone, potassium, magnesium, sodium, calcium, iron, and aluminum or any combination of them), vinegar, and sugar. The top of the molded porous carrier is then covered up with a plastic film or a cap to facilitate holding the porous carrier.

The present invention relates to a method of seasoning with a porous carbon material is essentially achieved by having the porous carbon material containing water base alkaloid to contact an object pending seasoning for the water base alkaloid to be released and dissolved in the object pending seasoning Furthermore, the porous carbon material further carries a second composition for seasoning and the second composition is also released and dissolved in the object pending seasoning

What is claimed is:

1. A manufacturing process of a porous carbon material functioning as a seasoning essentially comprised of having a material containing lignin thermally treated to be carbonized into a porous carrier containing multiple porosities and distributed with water base alkaloid.

2. The manufacturing process of the porous carbon material functioning as a seasoning as claimed in claim 1, wherein the material containing lignin before the thermal treatment is molded into a given shape.

3. The manufacturing process of the porous carbon material functioning as a seasoning as claimed in claim 1, wherein the thermal treatment includes a pre-dehydration stage (30˜110° C.), a temperature rising dehydration stage (111˜150° C.), an initial carbonization stage (151˜275° C.), a primary carbonization stage (276˜550° C.), and a refinery stage (551˜950° C.) with each stage heated under low oxygen containment; and the multi-stage heating process includes two hours at 30˜110° C., four hours at 111˜150° C., seven hours at 151˜275° C., fifteen hours at 276˜550° C., and eight hours at 551˜950° C.

4. The manufacturing process of the porous carbon material functioning as a seasoning as claimed in claim 1, wherein the material containing lignin is a bamboo stick, thermally treated at a temperature rise rate of 3° C.˜10° C. per minute until reaching the constant temperature range of 550° C.˜2000° C.

5. The manufacturing process of the porous carbon material functioning as a seasoning as claimed in claim 1, wherein a second or a plurality of composition is filled in multiple porosities of the porous carrier.

6. A manufacturing process of a porous carbon material functioning as a seasoning essentially comprised of having a material containing lignin thermally treated and carbonized into a porous carrier containing multiple porosities and distributed with water base alkaloid; and the porous carrier being molded into a specific form.

7. The manufacturing process of the porous carbon material functioning as a seasoning as claimed in claim 6, wherein the thermal treatment includes a pre-dehydration stage (30˜110° C.), a temperature rising dehydration stage (111˜150° C.), an initial carbonization stage (151˜275° C.), a primary carbonization stage (276˜550° C.), and a refinery stage (551˜950° C.) with each stage heated under low oxygen containment; and the multi-stage heating process includes two hours at 30˜110° C., four hours at 111˜450° C., seven hours at 151˜275° C., fifteen hours at 276˜550° C., and eight hours at 551˜950° C.
